(19) United States
(12) Patent Application Publication
(10) Pub. No.: US 2015/0171404 A1
(43) Pub. Date: Jun. 18, 2015

(54) BATTERY MODULE

(71) Applicant: Samsung SDI Co., Ltd., Yongin-si (KR)

(72) Inventor: Tae-Ho Kwon, Yongin-si (KR)

(21) Appl. No.: 14/562,599

(22) Filed: Dec. 5, 2014

(30) Foreign Application Priority Data
Dec. 16, 2013 (KR) 10-2013-0156219

(51) Int. Cl. H01M 2/20; H01M 2/10

(52) U.S. Cl. CPC H01M 2/206; H01M 2/204; H01M 2/1061; H01M 2/1077

(57) ABSTRACT

A battery module is provided in which battery cells are closely connected to each other, thereby improving the performance of the battery module. The battery module includes a plurality of battery cells, a terminal connector and a housing. Each battery cell has a terminal on one surface thereof, and the plurality of battery cells are aligned in one direction. The terminal connector connects adjacent terminals of first and second battery cells. The housing accommodates the plurality of battery cells therein. In the battery module, the terminal includes first and second contact portions formed in parallel and spaced apart from each other, and a first connecting portion connected to one end of the first contact portion and one end of the second contact portion. In the battery module, the terminal connector is forcibly inserted between the first and second contact portions.

### CROSS-REFERENCE TO RELATED APPLICATION

This application claims priority to and the benefit of Korean Patent Application No. 10-2013-0156219, filed on Dec 16, 2013, in the Korean Intellectual Property Office, the contents of which are incorporated herein by reference in their entirety.

### BACKGROUND

1. Field

The present disclosure relates to a battery module, and more particularly, to a battery module in which adjacent battery cells are closely connected to each other, thereby improving the performance of the battery module.

2. Description of the Related Art

As industries of electronics, communications and the like are rapidly developed, the spread of portable electronic devices such as camcorders, cellular phones and notebook PCs has recently increased. Accordingly, the amount of secondary batteries used has also increased. The secondary batteries can be used not only for portable electronic devices, but also for medium-sized and large-sized apparatuses such as electric tools, automobiles, space transportation means, motorbikes, motor scooters and aerial transportation means, which require high output and high power. The secondary batteries used for the medium-sized and large-sized apparatuses constitute a large-capacity battery module or battery pack by connecting a plurality of battery cells in series or in parallel.

A bus-bar is used to connect battery cells in series or parallel as described above. In this case, as the bus-bar is spot-welded to a terminal of the battery cell, an electrode contact area is small, and therefore, an electrode contact defect occurs. Accordingly, various studies on a method for maximizing the performance of a battery module by reducing connection contact resistance between electrodes have been conducted.

### SUMMARY

Embodiments provide a battery module having a terminal of which two or more surfaces can be contacted with a terminal connector.

Embodiments also provide a battery module having a structure which can increase the contact surface area between a terminal connector and a terminal portion.

Embodiments also provide a battery module having a terminal connector provided with an adhesive.

Embodiments also provide a battery module having a structure in which terminals of adjacent battery cells are closely coupled to each other.

Embodiments also provide a battery module having a fastener by which a terminal connector and a terminal are closely coupled to each other.

According to an embodiment of the present invention, a battery module is provided, which includes: a plurality of battery cells comprising a first battery cell and a second battery cell adjacent to the first battery cell, each of the plurality of battery cells having a terminal on one surface thereof, the plurality of battery cells being aligned in one direction; a terminal connector configured to connect terminals of the first battery cell and the second battery cell; and a housing configured to accommodate the plurality of battery cells therein, wherein at least one of the terminals includes a first contact portion and a second contact portion formed in parallel and spaced apart from each other, and a first connecting portion connected to a first end of the first contact portion and to a first end of the second contact portion, and wherein the terminal connector is configured to be forcibly inserted between the first contact portion and the second contact portion.

The first connecting portion may be perpendicular and connected to the first end of the first contact portion and to the first end of the second contact portion.

An opening may be formed between the first and second contact portions.

The terminal connector may be configured to be inserted into the opening toward the first connecting portion.

The terminal connector may include an adhesive on at least one surface of a terminal contact portion configured to be in contact with the first and second contact portions.

The adhesive may include a binder and a conductive filler.

The binder may be epoxy resin, acrylic resin or polyamine, and the conductive filler may be silver powder.

A terminal contact portion of the terminal may be of a size corresponding to the opening.

A thickness of the terminal contact portion may be less than a thickness of a non-terminal contact area with which the terminal is not contacted when the terminal connector is inserted in the terminal.

The terminal may further include a second connecting portion perpendicular to and connecting a second end of the first contact portion and a second end of the second contact portion.

The terminal connector may further include a roughened surface. The roughened surface may be formed on at least one surface of the terminal contact portion configured to be in contact with the first and second contact portions.

Fastening holes may be respectively formed in at least one side of the terminal and the terminal connector. The fastening holes may be vertically positioned on a same line and configured to be fastened by a fastener.

The housing may include a pair of end plates opposite to wide surfaces of the battery cells; a side plate configured to support side surfaces of the battery cells, the side plate connecting the pair of end plates to each other; and a bottom plate configured to support bottom surfaces of the battery cells.

The pair of end plates, the side plate and the bottom plate may be connected by bolts.

As described above, according to the battery module of one embodiment, the terminal and the terminal connector can be closely coupled to each other by coming into surface contact with each other, thereby improving the performance of the battery module.

Further, according to one embodiment, as the terminal connector is forcibly inserted into the opening formed in the terminal portion, it is unnecessary to perform an additional welding operation, and the terminal connector and the terminal can be easily coupled to each other. Accordingly, it is possible to reduce operating cost and to improve operating efficiency.

Further, according to another embodiment, the terminal connector is provided with a conductive adhesive to fill in the spaces between the terminal and the terminal connector. Accordingly, the terminal and the terminal connector can be closely coupled to each other, thereby improving the quality of the battery module.

Further, in another embodiment, as the terminal and the terminal connector are fastened by the fastener, the terminal and the terminal connector can be closely coupled to each other, thereby ensuring the safety of the battery module.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, the dimensions may be exaggerated for clarity of illustration. It is to be understood that when an element is referred to as being “between” two elements, it can either be the only element between the two elements, or one or more intervening elements may also be present. Also, like reference numerals refer to like elements throughout.

FIG. 1 is a perspective view of a battery module according to an embodiment of the present invention.

FIG. 2 is an exploded perspective view of the battery module of FIG. 1.

FIG. 3 is a perspective view showing a terminal according to an embodiment of the present invention.

FIG. 4A is a perspective view showing a terminal and a terminal connector according to an embodiment of the present invention, and FIG. 4B is a perspective view showing a terminal according to another embodiment of the present invention.

FIG. 5A is a perspective view showing a terminal connector according to another embodiment of the present invention, and FIG. 5B is a sectional view taken along line a-a′ of FIG. 5A.

FIG. 6 is a perspective view showing a terminal connector according to still another embodiment of the present invention.

FIG. 7A is a perspective view showing a terminal connector according to still another embodiment of the present invention, and FIG. 7B is a sectional view taken along line b-b′ of FIG. 7A.

FIGS. 8 and 9 are sectional views showing terminal connectors according to still other embodiments of the present invention.

FIG. 10 is an exploded perspective view showing a terminal connector and a terminal according to still another embodiment of the present invention.

### DETAILED DESCRIPTION

In the following detailed description, only certain exemplary embodiments of the present invention have been shown and described, simply for the purposes of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

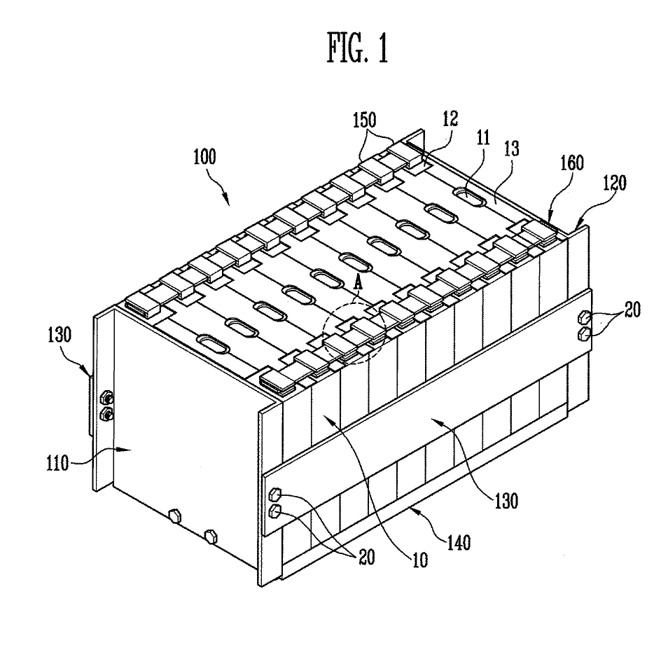

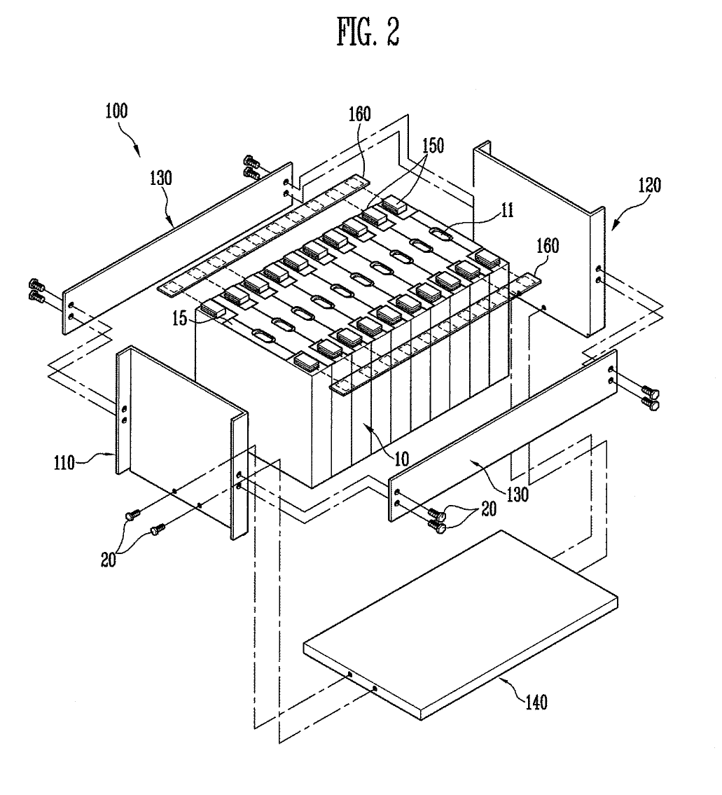

FIG. 1 is a perspective view of a battery module according to an embodiment of the present invention. FIG. 2 is an exploded perspective view of the battery module of FIG. 1.

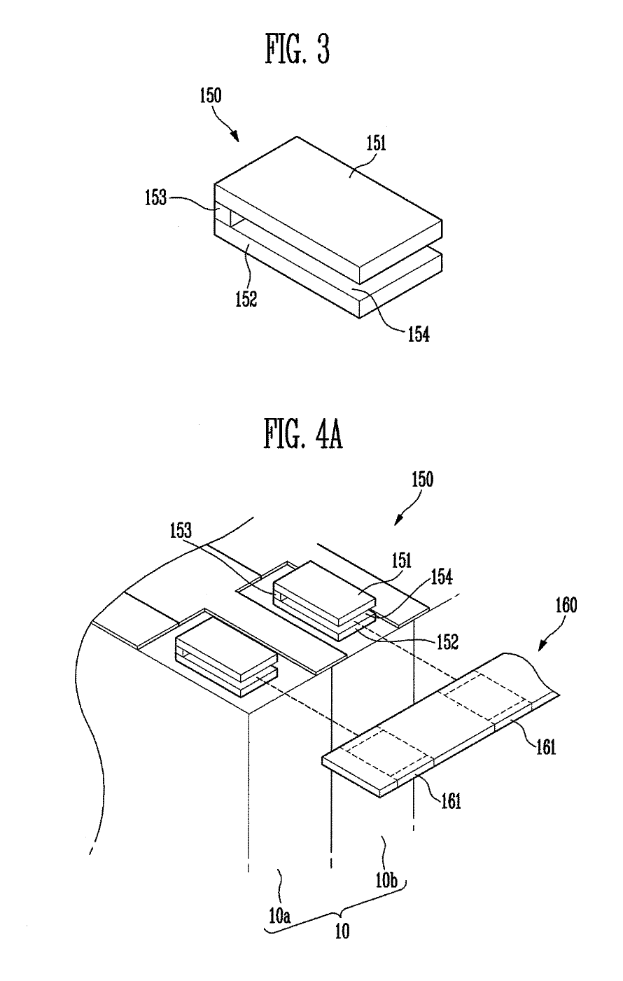

As shown in FIGS. 1 and 2, the battery module 100 according to this embodiment includes a plurality of battery cells 10 each configured to have terminals 150 on one surface 12 thereof, the plurality of battery cells 10 being aligned in one direction; a terminal connector 160 configured to connect the adjacent terminals 150 of first and second battery cells 10; and a housing 110, 120, 130 and 140 configured to accommodate the plurality of battery cells 10 therein. The terminal 150 may include first and second contact portions 151 and 152, a first connecting portion 153 configured to connect one end of the first contact portion 151 and one end of the second contact portion 152, and an opening 154 formed between the first and second contact portions 151 and 152 (see FIG. 3).

The battery cell 10 may include a battery case configured to have the one surface 12, and an electrode assembly and an electrolyte, which are accommodated in the battery case (see FIG. 1). The electrode assembly and the electrolyte generate energy through an electrochemical reaction therebetween. The one surface 12 may be provided with the terminals 150 electrically connected to the electrode assembly, and a vent 11 that is an exhaust passage of gas generated inside the battery cell 10. For example, the terminals 150 at opposite ends of the surface 12 may be positive and negative electrode terminals having different polarities from each other. The terminals 150 of adjacent battery cells 10 may be electrically connected in series or parallel by the terminal connector 160. A gasket 13 made of an electrically insulating material may be provided on the one surface 12 of the battery cell 10. The terminal 150 protrudes on an outside of the gasket 13, and the terminals 150 may be connected by the terminal connector 160 on the gasket 13.

The plurality of battery cells 10 may be aligned in one direction so that wide surfaces of the battery cells 10 are facing each other. The plurality of aligned battery cells 10 may be fixed by the housing 110, 120, 130 and 140. The housing 110, 120, 130 and 140 may include a pair of end plates 110 and 120 opposite to the wide surfaces of the battery cells 10, and a side plate 130 and a bottom plate 140, which connect the pair of end plates 110 and 120. The side plate 130 may support a side surface of the battery cell 10, and the bottom plate 140 may support a bottom surface of the battery cell 10. The pair of end plates 110 and 120, the side plate 130 and the bottom plate 140 may be connected by bolts 20.

FIG. 3 is a perspective view showing a terminal according to an embodiment of the present invention.

As shown in FIG. 3, the terminal 150 according to this embodiment may include first and second contact portions 151 and 152 formed in parallel and spaced apart from each other, a first connecting portion 153 connected perpendicularly to one end of the first contact portion 151 and one end of the second contact portion 152, and an opening 154 formed between the first and second contact portions 151 and 152. The terminal connector 160 described later is forcibly inserted into the opening 154 in the direction of the first connecting portion 153. Therefore, the size of the opening 154 is preferably formed to correspond to that of the terminal connector 160.

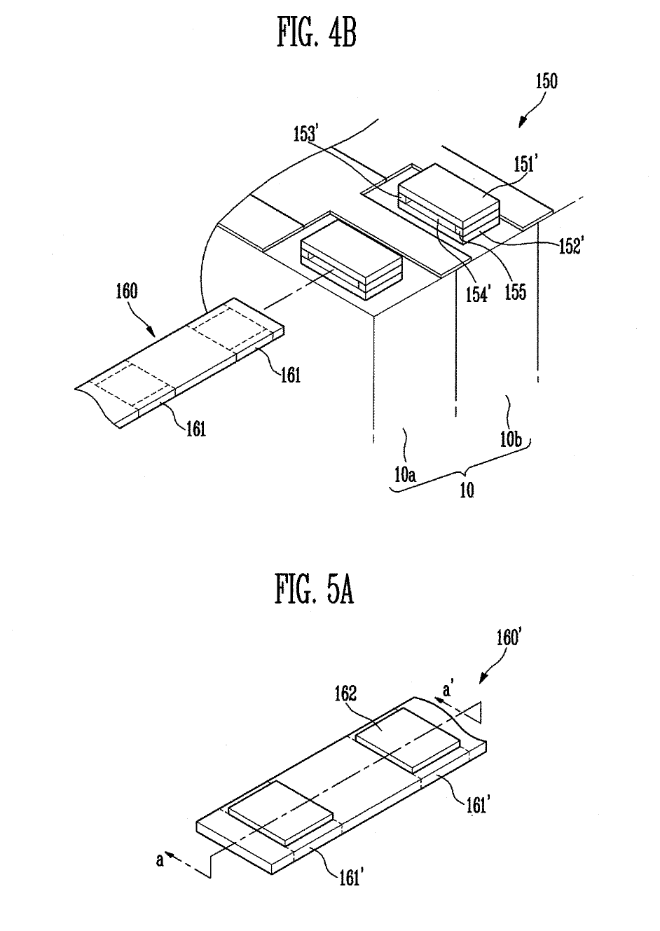

FIG. 4A is a perspective view showing a terminal and a terminal connector according to an embodiment of the present invention, and FIG. 4B is a perspective view showing a terminal according to another embodiment of the present invention.

As shown in FIG. 4A, the terminal connector 160 is forcibly inserted into the openings 154 of the terminals 150 provided on first and second battery cells 10a and 10b that are battery cells 10 adjacent to each other. Accordingly, upper and lower surfaces of the terminal connector 160 respectively come in surface contact with the first and second contact portions 151 and 152.

In this case, the terminal connector 160 may be inserted into the opening 154 in the direction of the first connecting portion 153.

As shown in FIG. 4B, the terminal 150 may further include a second connecting portion 155 connected perpendicularly to the other ends of first and second contact portions 151′ and 152′. An opening 154′ is formed by the second connecting portion 155 in a shape that surrounds an outer surface of the terminal connector 160 when the terminal connector 160 is inserted into the opening 154. Accordingly, the contact surface area between the terminal connector 160 and the terminal 150 is increased, so that the terminal connector 160 and the terminal 150 can be closely coupled to each other. Here, the terminal connector 160 refers to a bus-bar.

Meanwhile, terminal contact portions 161 are respectively formed at portions of the terminal connecting member 160, coming in surface contact with the first and second contact portions 151 and 152. In this case, the terminal contact portion 161 is preferably formed in a size corresponding to that of the opening 154 so as to be forcibly inserted into the opening 154.

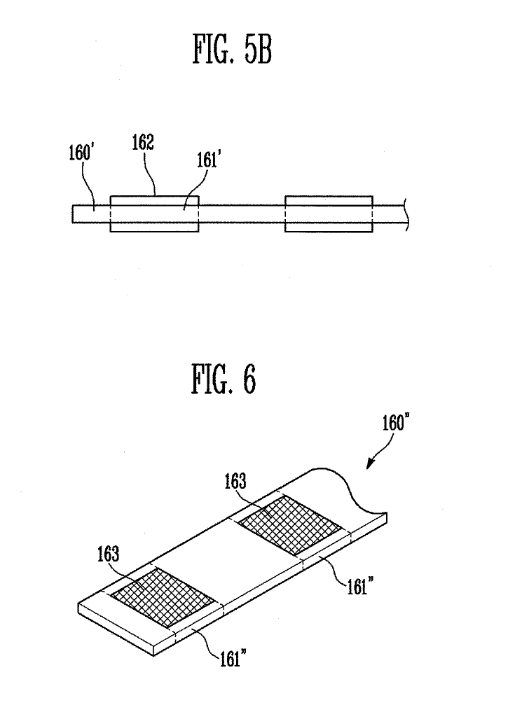

FIG. 5A is a perspective view showing a terminal connector according to another embodiment of the present invention, and FIG. 5B is a sectional view taken along line a-a′ of FIG. 5A. FIG. 6 is a perspective view showing a terminal connector according to still another embodiment of the present invention.

As shown in FIGS. 5A and 5B, an adhesive 162 may be provided to a terminal contact portion 161′ of the terminal connector 160′. The adhesive 162 may include a binder and a conductive filler. Specifically, the adhesive 162 may include a binder made of at least one of epoxy resin, acrylic resin and polyamine, and a conductive filler made of silver powder. The adhesive 162 is placed on at least one surface of the terminal contact portion 161′, specifically the entire or a portion of the at least one surface of the terminal contact portion 161′. When the terminal connector 160′ is inserted into the opening 154, the adhesive 162 closely fills in the spaces produced between the first and second contact portions 151 and 152 and the terminal contact portion 161′, thereby improving the coupling performance between the terminal 150 and the terminal connector 160′.

As shown in FIG. 6, a roughened surface 163 may be formed at a terminal contact portion 161″ of the terminal connector 160″. The terminal connector 160″ and the terminal 150 are made of an electrical conductor, and may be metal having a smooth surface. If the terminal connector 160″ in which the roughened surface 163 is formed at the entire or a portion of the terminal contact portion 161″ is inserted into the opening 154, the friction between the terminal contact portion 161″ and the first and second contact portions 151 and 152 is improved, so that it is possible to improve the coupling performance between the terminal 150 and the terminal connector 160″.

FIG. 7A is a perspective view showing a terminal connector according to still another embodiment of the present invention, and FIG. 7B is a sectional view taken along line b-b′ of FIG. 7A.

As shown in FIG. 7A, in the battery module according to this embodiment, the terminal connector 260 may be connected to terminals 250 that are adjacent to each other and each provided on one surface of the first and second battery cells 10a and 10b, respectively. In this case, a thickness h of a terminal contact portion 261 may be formed thinner than a thickness H of a non-terminal contact area with which the terminal is not contacted in order to increase the contact surface area between the terminal connector 260 and the terminal 250 and to secure a space in which an adhesive 262 is provided (see FIG. 7B).

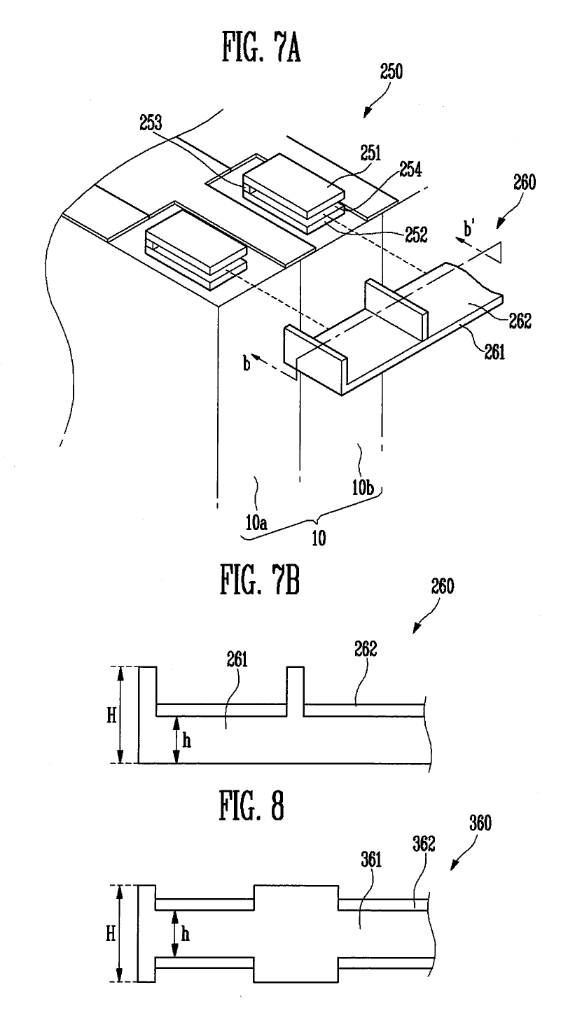

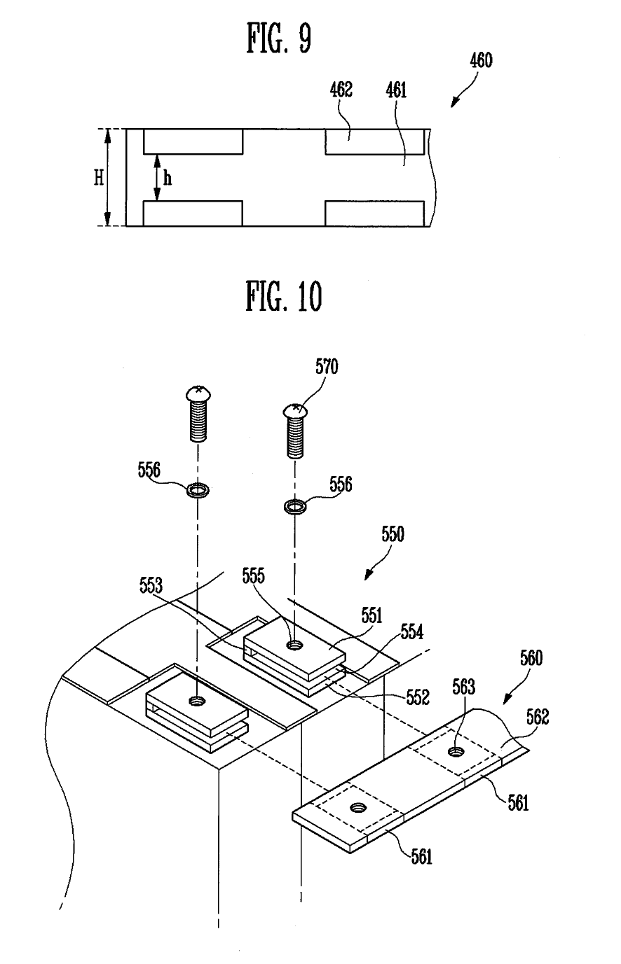

FIGS. 8 and 9 are sectional views showing terminal connectors according to still other embodiments of the present invention.

FIGS. 8 and 9 show a case where the thicknesses h of terminal contact portions 361 and 461 are formed thinner than those H of the terminal connectors 360 and 460, respectively. The shapes of the terminal contact portions 361 and 461 are not limited to those shown in FIGS. 8 and 9. That is, the shapes of the terminal contact portions 361 and 461 may be formed in different shapes as long as the thicknesses h of terminal contact portions 361 and 461 are formed thinner than the thicknesses H of the terminal connectors 360 and 460, respectively.

FIG. 10 is an exploded perspective view showing a terminal connector and a terminal according to still another embodiment of the present invention.

As shown in FIG. 10, in the battery module according to this embodiment, the terminal connector 560 may be connected to terminals 550 that are adjacent to each other and each provided on one surface of the first and second battery cells 10a and 10b, respectively. The terminal 550 may include first and second contact portions 551 and 552 formed in parallel and spaced apart from each other, a first connecting portion 553 connected perpendicularly to one end of the first contact portion 551 and one end of the second contact portion 552, and an opening 554 formed between the first and second contact portions 551 and 552.

In the terminal connector 560, a terminal contact portion 561 may be configured to come into surface contact with the first and second contact portions 551 and 552. That is, fastening holes 555 and 563 are respectively formed at least through the first contact portion 551 and one side of the terminal contact portion 561. When the fastening holes 555 and 563 are vertically positioned along the same line, a fastener 570 is inserted into the fastening holes 555 and 563, so that the terminal connector 560 and the terminal 550 can be fastened to each other.

Meanwhile, the fastening hole 555 may be formed in only the first contact portion 551 so that a lower surface of the terminal contact portion 561 can be entirely contacted with an upper surface of the second contact portion 552. Accordingly, the fastener 570 is inserted into the fastening hole 555 of the first contact portion 551 to press an upper surface of the terminal contact portion 561. In this case, the lower surface of the terminal contact portion 561 is in close contact with the upper surface of the second contact portion 552.

A washer 556 may be further provided between the upper surface of the second contact portion 552 and the fastener 570. The washer 556 prevents the fastener 570 from being unscrewed from the second contact portion 552 and the terminal connector 560.

An adhesive 562 may be further provided on the upper or lower surface of the terminal contact portion 561 so that the terminal 550 and the terminal connector 560 are closely fastened to each other.

As described above, the terminal 550 and the terminal connector 560 are closely fastened to each other by the fastener 570, so that it is possible to improve the coupling performance between the terminal 550 and the terminal connector 560.

According to the battery module of the present invention, the terminal and the terminal connector can be closely fastened to each other by coming into surface contact with each other, so that it is possible to improve the performance of the battery module and to ensure the safety of the battery module.

Further, the terminal connector is provided with a conductive adhesive fills in the spaces between the terminal and the terminal connector, thereby improving the quality of the battery module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned in one direction, the plurality of battery cells including at least one pair of battery cells adjacent one another, the at least one pair of battery cells including a terminal on one surface, each terminal defining first and second contact portions parallel to and spaced from one another, and joined by a first connecting portion at a first end of the first contact portion and a first end of the second contact portion, thereby defining an opening between the first and second contact portions;
a terminal connector configured to be inserted into the openings of the terminals of the at least one pair of battery cells, thereby connecting the terminals of the at least one pair of battery cells; and
a housing configured to accommodate the plurality of battery cells therein.

2. The battery module of claim 1, wherein the first connecting portion is perpendicular to the first ends of the first and second contact portions.

3. The battery module of claim 1, wherein the terminal connector is configured to be inserted into the opening toward the first connecting portion.

4. The battery module of claim 1, wherein the terminal connector includes an adhesive configured to adhere the terminal connector to at least one surface of the first contact portion or at least one surface of the second contact portion.

5. The battery module of claim 4, wherein the adhesive comprises a binder and a conductive filler.

6. The battery module of claim 5, wherein the binder is at least one of epoxy resin, acrylic resin or polyamine, and the conductive filler is silver powder.

7. The battery module of claim 4, wherein a terminal contact portion of the terminal is of a size corresponding to the opening.

8. The battery module of claim 7, wherein a thickness of the terminal contact portion is less than a thickness of a non-terminal contact area with which the terminal is not contacted when the terminal connector is inserted in the terminal.

9. The battery module of claim 1, wherein the terminal further includes a second connecting portion perpendicular to and connecting a second end of the first contact portion and a second end of the second contact portion.

10. The battery module of claim 1, wherein the terminal connector further includes at least one roughened surface corresponding to at least one opening of a terminal.

11. The battery module of claim 1, wherein fastening holes are defined by at least one terminal and the terminal connector, and are aligned to receive a fastener when the terminal connector is inserted into the terminal.

12. The battery module of claim 1, wherein the housing includes:
a pair of end plates opposite to wide surfaces of the battery cells;
a side plate configured to support side surfaces of the battery cells, the side plate connecting the pair of end plates to each other; and
a bottom plate configured to support bottom surfaces of the battery cells.

13. The battery module of claim 12, wherein the pair of end plates, the side plate and the bottom plate are connected by bolts.
